(19) United States
(12) Patent Application Publication
(10) Pub. No.: US 2008/0002408 A1
(43) Pub. Date: Jan. 3, 2008

(54) Controller Of Illumination System In Optical Engine

(75) Inventors: Shung-Hoon Hwang, Seoul (KR); Byeong-Nam Ann, Gyeonggi-do (KR); Sang-Cheon Jeon, Gyeonggi-do (KR)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: SEKONIX CO, LTD., Gyeonggi-do (KR)

(21) Appl. No.: 11/623,331

(22) Filed: Jan. 16, 2007

(30) Foreign Application Priority Data
Jul. 3, 2006 (KR) 10-2006-0061884

(51) Int. Cl. F21S 8/00

(52) U.S. Cl. 362/277

(57) ABSTRACT

Provided is a controller of an illumination system in an optical engine, in which a rear end of a light tunnel is fixed to a barrel and a front end of the light tunnel is movably installed inside the barrel, comprising: control openings being respectively bored through an upper part of the barrel; control screws being respectively connected to the control openings and moving the light tunnel in an oblique direction, each control screw with an end being obliquely in contact with the light tunnel; and an elastic body being installed in the barrel, opposite to the control screws, to elastically support the light tunnel. The controller of the illumination system controls the light tunnel to be moved in the oblique direction in the barrel, thereby enabling the light tunnel to be quickly and easily moved to be controlled, improving the controllability and shortening the control time.

### BACKGROUND OF THE INVENTION

1. Technical Field

The present invention relates to a controller of an illumination system in an optical engine and, more particularly, to a controller of an illumination system in an optical engine, which controls a light tunnel to be moved in an oblique direction in a barrel of an optical engine installed in a projection TV, thereby enabling the light tunnel to be easily and quickly operated in a control direction desired by a user.

2. Discussion of Related Art

Generally, projection televisions and liquid crystal display projectors are included in the electronic products which realize a large picture on a screen, independently from an original image, by the light scanned through a light source and enlarged and transmitted through an illumination system and a synthesis system.

A projection television using an optical engine will be described with respect to the constitution and principle as follows:

As illustrated in FIG. 1, a projection TV 10 comprises: an optical engine 20 for emitting light; a projection lens 21 for enlarging and transmitting the light emitted by the optical engine 20, a reflection mirror 30 for reflecting the light enlarged and transmitted by the projection lens 21 on the entire surface of a screen, and a transmissive screen 40 for realizing an image by the light reflected by the reflection mirror 30.

The optical engine 20 is positioned at a lower part of a case 11 of the projection TV. The reflection mirror 30 is positioned at a rear upper part of the case 11 so that the light enlarged and transmitted by the projection lens 21 is reflected toward the transmissive screen 40. The transmissive screen 40 is positioned at the front of the case 1, opposite to the reflection mirror 30, so that the light reflected by the reflection mirror 30 is realized on the entire surface of the screen 40.

As illustrated in FIGS. 2 and 3, the optical engine 20, which emits light on the screen 40 through the reflection mirror 30 of the projection TV 10, comprises: a light tunnel assay (hereinafter, named as “a light tunnel”) 25 for generating light; a barrel 22 where the light tunnel 25 is positioned, and a number of lenses (not shown), positioned in the barrel 22, for regulating the intensity of light, concentrating light to prevent spreading, and correcting the linearity of light.

One end of the light tunnel 25 is fixed to the barrel 22 and the other end thereof is movably installed in the barrel 22.

As illustrated in FIG. 3, the light tunnel 25 in the optical engine 20 is movable in up and down and side to side directions in the barrel 22.

That is, a control opening 23 is bored through an upper part of the barrel 22 and a control opening 24 is bored through one side part of the barrel 22. The control opening 23 is connected to an upper part of the light tunnel 25, by a control screw (not shown) with an end contacting with the upper part of the light tunnel 25. The control opening 24 is connected to a side part of the light tunnel 25, by a control screw (not shown) with an end contacting with the side part of the light tunnel 25.

Opposite to the control screws, springs 26 and 27 are installed inside the barrel 22, that is, at an inside lower part and the other side part of the barrel 22, thereby elastically supporting the light tunnel 25 toward the control screws.

For a more perfect image, the light tunnel 25 is movably controlled by the control screws and the springs 26 and 27.

However, the conventional light tunnel 25 is controlled only linearly in up and down and side to side directions in the barrel 22, by the control screws positioned at the upper part and one side part of the barrel 22, and by the springs 26 and 27 with the elasticity acting from the inner lower part and the other side part of the barrel 22 to the control screws. Therefore, the operation of controlling the light tunnel 25 is performed in a dual manner, that is, to move the light tunnel 25 horizontally and vertically. Consequently, the process of controlling the light tunnel 25 is troublesome and inconvenient, the control operability is low, and it takes a long time to control the light tunnel 25

### SUMMARY OF THE INVENTION

Therefore, the present invention is directed to provide a controller of an illumination system in an optical engine, which includes a plurality of control screws in an upper part of a barrel and a plurality of springs in an inner lower part of the barrel, opposite to the control screws, to move a light tunnel in an oblique direction in the barrel, thereby enabling the light tunnel to be quickly and easily moved to be controlled in a control direction as a user desires, improving controllability and shortening a time needed for a control operation.

In accordance with an embodiment, the present invention provides a controller of an illumination system in an optical engine, in which a rear end of a light tunnel is fixed to a barrel and a front end of the light tunnel is movably installed inside the barrel, comprising, a control opening being bored through an upper part of the barrel; a control screw with an end being obliquely in contact with the light tunnel, the control screw being connected to the control opening, to move the light tunnel obliquely; and an elastic body being installed in the barrel, opposite to the control screw, to elastically support the light tunnel.

The elastic body may include one end in which a mounting part is formed and the other end in which a spring part is formed to be bent, wherein the mounting part is fixed to an inner side of the barrel, and the spring part is divided to contact with the light tunnel obliquely and elastically supports the light tunnel.

The front end of the light tunnel includes a square-shaped cover, wherein the cover is installed in an angled orientation having a rhombus shape inside the barrel and the cover includes a slope on which the control screw and the spring part of the elastic body are installed in contact.

### BRIEF DESCRIPTION OF THE DRAWINGS

The above and other features and advantages of the present invention will become more apparent to those of ordinary skill in the art by describing in a detail preferred embodiment(s) thereof with reference to the attached drawings in which.

FIG. 1 is a schematic view for explaining the principle of a general projection TV;

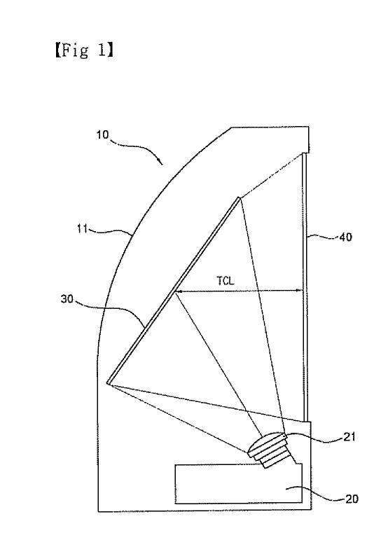

FIG. 2 is a view illustrating a conventional optical engine;

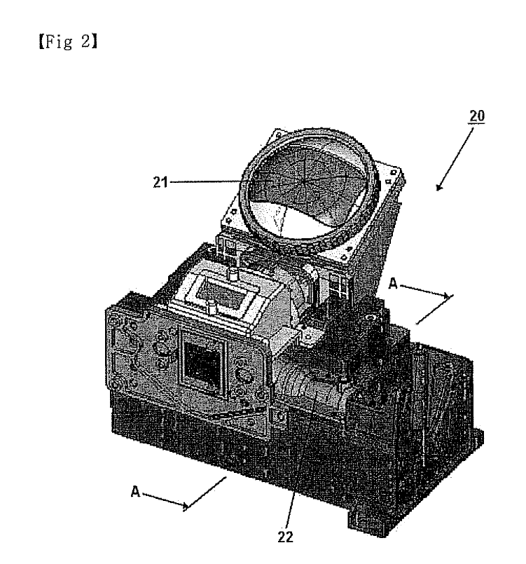

FIG. 3 is a section view illustrating a controller of an illumination system in the conventional optical engine, taken along Line A-A of FIG. 2;

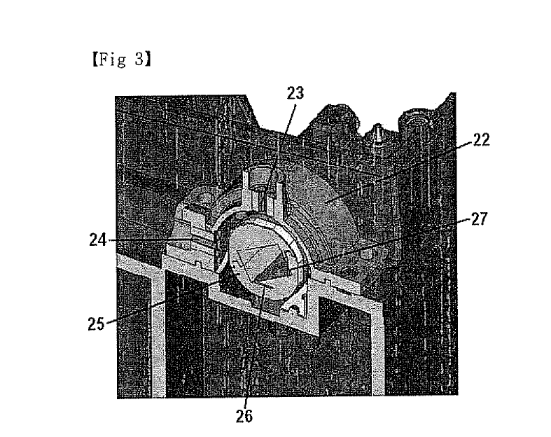

FIG. 4 is a separate perspective view illustrating an illumination system and a barrel in an optical engine according to the present invention;

FIG. 5 is a sectional perspective view illustrating a controller of the illumination system, which is indicated as square dot line portion of FIG. 4; and

FIG. 6 is a plan view illustrating the controller of the illumination system according to the present invention.

### DETAILED DESCRIPTION OF THE INVENTION

The present invention will now be described more fully hereinafter with reference to the accompanying drawings, in which a preferred embodiment(s) of the invention is shown. Same reference numbers refer to the same element between the present invention and the prior art. No overlapping description between the present invention and the prior art will be presented.

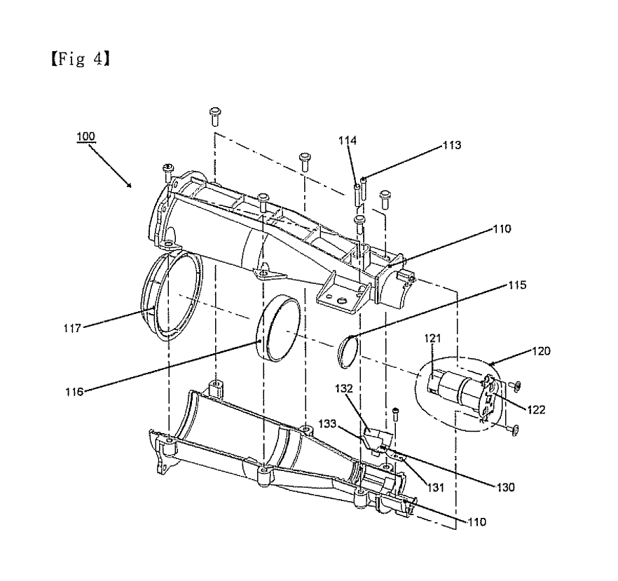

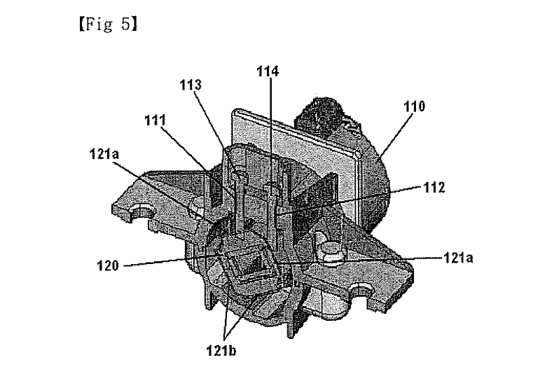

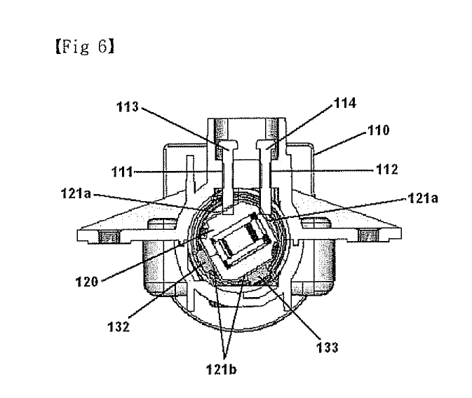

FIG. 4 is a separate perspective view illustrating an illumination system and a barrel in an optical engine 100 according to the present invention, FIG. 5 is a sectional perspective view illustrating a controller of the illumination system, which is indicated as square dot line portion of FIG. 4, and FIG. 6 is a plan view illustrating the controller of the illumination system in the optical engine 100.

As illustrated in FIG. 4, the optical engine 100 comprises a controller for controlling a light tunnel 120 in a barrel 110.

The light tunnel 120 is installed in the barrel 110, and a rear end of the light tunnel 120 is fixed to the barrel 110 by a bracket 122 and a front end of the light tunnel 120 is elastically supported to be movable in the barrel 110.

A square-shaped cover 121 is positioned at the front end of the light tunnel 120, and the cover 121 is installed in an angled orientation having a rhombus shape, inside the barrel 110.

A plurality of control openings 111 and 112 are positioned to be spaced apart from each other at an upper part of the barrel 110. The control openings 111 and 112 are spaced from each other, to be positioned at both sides of the upper summit (i.e., the highest summit of the rhombus shape) of the cover 121.

Control screws 113 and 114 are respectively connected to the control openings 111 and 112. Lower parts of the control screws 113 and 114 are respectively connected to upper slopes 121a formed on both sides of the highest summit of the cover 121.

In an inner side of the barrel 110, opposite to the control screws 113 and 114, an elastic body 130 is installed to elastically support lower slopes 121b formed on both sides of the light tunnel 120, based on the lower summit (i.e., is the lowest summit of the rhombus shape).

The elastic body 130 includes one end with a mounting part 131 and the other end with a plurality of spring parts 132 and 133 formed to be bent upwardly. The mounting part 131 is fixed to the inner side of the barrel 110, and the spring parts 132 and 133, divided to respectively correspond to the lower slopes 121b of the light tunnel 120, elastically support the lower slopes 121b.

The elasticity of the spring parts 132 and 133 is increased by the mounting part 131 fixed to the inner side of the barrel 110.

The front end of the light tunnel 120 is controllably moved in an oblique direction in the barrel 110, by the control screws 113 and 114 and the elastic body 130.

Reference numerals “115”, “116” and “117”, which are not explained in the description of the invention, indicate a number of lenses which are installed in the barrel 110 for the illumination system to regulate the intensity of light, prevent the spread of light, and concentrate light to correct the linearity of light.

The controller of the illumination system in the optical engine according to the present invention, which has the above-described constitution, will be described with respect to the operation, below.

After the distance between a position of the light tunnel 120 being installed in the barrel 110 and a position of the light tunnel 120 to be controlled is calculated, the control screws 113 and 114 respectively connected to control openings 111 and 112 on the upper part of the barrel 110 are controlled.

(Although both control screws 113 and 114 are controllable, the description is presented regarding one control screw to be controlled, for a clear understanding of the invention.) For example, when only the control screw 113 (positioned at the left of FIGS. 5 and 6) connected to the control opening 111 is controlled, the control screw 113 presses the upper slope 121a of the cover 121 of the light tunnel 120 in contact with the lower part of the control screw 113 while the control screw 113 is received in the control opening 111.

Then, the front end of the light tunnel 120 is controllably moved in the downwardly oblique direction in the barrel 110, by the pressurizing force of the control screw 113 and the upper slope 121a.

The spring part 133 of the elastic body 130, which is installed in a diagonal direction to the control screw 113, is pressed.

The light tunnel 120 is moved in the obliquely direction in the barrel 110, i.e., at right angles with the illumination system, only by the single operation of connecting the control screw 113 to the control opening 111 of the barrel 110. Accordingly, the light tunnel 120 is quickly and easily moved to be controlled in the control direction desired by a user, thereby improving the controllability and shortening the control time.

When the control screw 113 is loosened from the control opening 111 to control the light tunnel 120, the pressurizing force of the control screw 113 pressurizing the cover 121 of the light tunnel 120 is gradually removed as the control screw is unscrewed from the control opening 111.

Simultaneously, the elasticity applied to the spring part 133 of the elastic body 130, which is pressed between the cover 121 of the light tunnel 120 and the barrel 110 by the pressurizing force of the control screw 113, acts on the lower slope 121b of the cover 121. Accordingly, the front end of the light tunnel 120 is controllably moved upwardly, i.e., in the oblique direction, in the barrel 110, by the control screw 113 being unscrewed, the spring part 133 with the elasticity, and the lower slope 121b.

As described above, in the controller of the illumination system in the optical engine according to the present invention, the light tunnel is moved in the oblique direction in the barrel by the control screws connected at the upper part of the barrel and the elastic body installed in the inner side of the barrel, opposite to the control screws, thereby enabling the light tunnel to be easily moved to be controlled, improving the controllability and shortening the control time.

The invention has been described using preferred exemplary embodiments. However, it is to be understood that the scope of the invention is not limited to the disclosed embodiments. On the contrary, the scope of the invention is intended to include various modifications and alternative arrangements within the capabilities of persons skilled in the art using presently known or future technologies and equivalents. The scope of the claims, therefore, should be accorded the broadest interpretation so as to encompass all such modifications and similar arrangements.

What is claimed is:

1. A controller of an illumination system in an optical engine, in which a rear end of a light tunnel is fixed to a barrel and a front end of the light tunnel is movably installed inside the barrel, comprising:
control openings being respectively bored through an upper part of the barrel;
control screws being respectively connected to the control openings and moving the light tunnel in an oblique direction, each control screw with an end being obliquely in contact with the light tunnel; and
an elastic body being installed in the barrel, opposite to the control screws, to elastically support the light tunnel,
wherein a cover in a square shape being installed at the front end of the light tunnel, the cover being obliquely installed in an angled orientation having a rhombus shape, in the barrel, and the cover including slopes with which the control screws and the spring parts of the elastic body are installed to be in contact.

2. The controller of an illumination system of claim 1, wherein the elastic body includes one end with a mounting part and the other end with spring parts being formed to be bent, the mounting part being fixed to an inner side of the barrel, and the spring parts being divided to obliquely contact with the light tunnel and elastically supporting the light tunnel.
